(19) United States
(12) Patent Application Publication
(10) Pub. No.: US 2005/0061846 A1
(43) Pub. Date: Mar. 24, 2005

(54) Magnetic roller

(75) Inventors: David LaVerne Seaberg, Rockford, IL (US); James K. Ward, Rockton, IL (US); Zachary Stephan Roberts, Winnebago, IL (US); Kendall Eugene Schlittler, Brodhead, WI (US)

Correspondence Address: MCANDREWS HELD & MALLOY, LTD, 500 WEST MADISON STREET, SUITE 3400, CHICAGO, IL, 60661, US

(73) Assignee: Martin Automatic, Inc.

(21) Appl. No.: 10/912,961

(22) Filed: Aug. 6, 2004

Related U.S. Application Data
(60) Provisional application No. 60/495,209, filed on Aug. 14, 2003.

(51) Int. Cl. H02P 15/00

(52) U.S. Cl. 226/118.3; 310/103

(57) ABSTRACT

A magnetic roller system configured for use within a web handling system, the system including a drive hub, and a roller that is magnetically coupled to the drive hub. The roller is configured to support a web of material. An adjustable gap is defined between the drive hub and the roller. The strength of the magnetic coupling increases as the adjustable gap decreases.

### RELATED APPLICATIONS

This application relates to and claims priority benefits from U.S. Provisional Patent Application No. 60/495,209 entitled “Improved Magnetic Roller,” filed Aug. 14, 2003, which is incorporated by reference herein in its entirety.

### BACKGROUND OF THE INVENTION

Embodiments of the present invention generally relate to rollers for handling moving webs of various materials, and more particularly, to improved rollers configured to handle relatively high speed, fragile webs, such as webs of nonwoven materials utilized in the manufacture of disposable diapers and the like.

Manufacturers, whose processes involve web handling, continually seek higher web processing speeds. Disposable diaper manufacturers are illustrative of such manufacturers because increasing the speed of the webs utilized in making disposable diapers can significantly reduce manufacturing costs on a per diaper basis. The webs used in manufacturing disposable diapers, especially the webs of nonwoven materials, tend to be relatively fragile, and this has often limited the forces that can be exerted in the webs during handling.

In many manufacturing processes involving web handling, webs are introduced into the process from a roll of the web material. Zero-speed splicers are often used to splice the beginning end of the web from a new roll onto the trailing end of an expiring roll. For the zero-speed splicer to work appropriately, the travel speed of the moving web at the splicing point is typically brought to zero. After the webs are spliced together, the web is subsequently accelerated back up to the desired web processing speed.

A festoon assembly is used to maintain the speed of the manufacturing process. Typically, the festoon assembly includes rollers that are used for the handling and conveyance of web materials, such as webs of nonwoven, plastic, paper, filter and film materials, from one point in a manufacturing process to another. The surfaces of web-handling rollers are usually shaped to a desired profile and are typically required to be rigid, due to the fact that surface imperfections and flexure in web rollers may lead to wrinkles and other imperfections in the web. To maintain the required rigidity and surface requirements, prior web rollers have typically been made from relatively heavy material, such as steel. As a result, such web rollers have a substantial amount of inertia.

To attempt to handle high-rate speed changes with high-inertia rollers, especially in processes including zero speed web splicers, the web handling processes have been required to use extra equipment, including control systems, power supplies and prime movers. This equipment is generally relatively expensive and also requires space on the already crowded, short-of-space manufacturing floor. Also, relatively large amounts of energy must be expended to control the motion of high-inertia rollers.

In addition, such standard web rollers have also required relatively heavy bearings for support. Heavy bearings, in turn, have a substantial amount of friction. The bearing friction continually acts against the acceleration of the web roller. To counteract the bearing friction in standard web rollers, the web handling process requires higher powered equipment and larger amounts of energy than would be required with a low-friction roller.

It has been proposed to convey web material by supporting the web material directly using forced air. For instance, U.S. Pat. No. 5,360,152 describes a cylinder with an outer surface that is perforated with multiple openings to form a bearing or gliding surface for the web material. A disadvantage, however, to supporting the web material directly with air is that many web materials, such as non-wovens, are porous, and supporting a porous web directly with forced air is ineffective. Another disadvantage is that many web processes require the support of flat and rigid roller surfaces to reduce wrinkling and other web imperfections. Air fails to provide the levels of support typically provided by rigid roller surfaces.

Others have suggested using a fluid (including air) to support a web guide roller. U.S. Pat. No. 5,246,155 (the “'155 patent”) discloses a roller that includes end seal covers and a support body generally in the shape of a hollow pipe. A thin, cylindrical roller body is carried by, and is concentric with, the support body. The annular space between the roller body and the support body is filled with a suitable pressure fluid, such as oil. The '155 patent, however, also mentions air as a possible fluid. The pressure fluid is introduced into the annular space by a plurality of equi-radially spaced and disposed feed lines, and is withdrawn from the annular space primarily through deflector channels disposed at the ends of the support body. Although the '155 patent discloses that the roller body is allowed to rotate with respect to the roller support body in an essentially frictionless manner, this statement must be questioned. With the pressure fluid exerting the same pressure throughout the annular space on the roller body the force exerted by the web, as it passes about a portion of the roller body, would cause the portion of the roller body to be moved into friction contact with an adjacent portion of the roller support body. Such contact may be said to be essentially frictionless in the context of a printing press employing a paper web, and particularly when oil is the pressure fluid. However, if air were to be employed, the frictional contact would render the patented web guide roller unusable, particularly if attempts were made to use the patented web guide roller to handle relatively high speed, relatively fragile webs, such as used in the manufacture of disposable diapers.

Those working in the art of handling relatively high speed, relatively fragile webs have long recognized that a need existed for an improved web-handling roller that has low inertia and low friction and that is capable of providing rigid support for such webs.

A web handling system is shown and described in U.S. Pat. No. 4,915,282 (the “'282 patent”), which is hereby incorporated by reference in its entirety. When a material splice occurs, the floating portion of the festoon assembly moves up and down due to the fact that the web being supplied to the festoon assembly is stopped in order for the splice to occur. However, the festoon, or accumulator, assembly is adapted to provide a constant output of material therethrough. Thus, as the web supplied to the festoon assembly is stopped, the festoon assembly moves in response thereto so that the output remains constant. As the web is spliced and the input of the web returns to a normal rate, the festoon assembly moves up or down in response thereto.

When the splice occurs, the various rollers in the festoon assembly move at different rates of rotation. As such, each roller exerts a different amount of inertial force on the web passing therethrough. For example, the roller at the portion of the festoon assembly where the web exits runs at a higher speed, and therefore exerts a different force on the web, than the roller proximate the portion of the festoon assembly where the web enters. Because the web may be fragile, the web may be damaged by varying tensions, forces, and stresses caused by varying inertial forces through the festoon assembly.

U.S. Pat. No. 6,641,513 (the “'513 patent), which is hereby incorporated by reference in its entirety, discloses a low inertia, low friction roller that is particularly adapted to handling relatively high speed, fragile running webs. The '513 patent discloses a roller including an inner tube and an outer tube. The outer tube is disposed substantially coaxially about the inner tube and is rotatable with respect to the inner tube. An annular gap is defined between the inner and outer tubes and has a first portion that is supplied with a restricted flow of a pressurized compressible fluid and that is adjacent to the portion of the outer tube about which the web passes. A second portion of the annular gap is circumferentially spaced from the first portion of the annular gap and communicates with a fluid exhaust passage in the inner tube. The dimensions of the annular gap are selected so that the fluid pressure in the first portion is greater than the fluid pressure in the second portion and so that the pressure of the fluid in the first portion of the annular gap will substantially balance the force exerted by the web on the outer tube as the web passes about the outer tube.

The '513 patent, however, relates to a system and method of allowing a relatively light mass to spin. In general, the roller described in the '513 patent utilizes various tubes and fluid. In some applications, the mass of the roller described in the '513 patent may still be too great, thereby causing excessive amounts of inertia during a web handling process.

Thus, a need exists for an improved, efficient and cost-effective roller that may be used with conventional web handling systems. Further, a need exists for a system and method for counteracting inertial and frictional forces during a web handling process.

### BRIEF SUMMARY OF THE INVENTION

Certain embodiments of the present invention provide a web handling system, including a plurality of rolls of web material, a splice unit configured to splice a first end of web material from a first of said plurality of rolls to a second end of web material from a second of said plurality of rolls, and a plurality of roller assemblies supporting the web material throughout the web handling system. Each of the plurality of roller assemblies includes a drive hub, and a roller that is magnetically coupled to the drive hub. The roller is configured to support the web of material so that the web of material passes around at least a portion of the roller. An adjustable gap is defined between the drive hub and the roller. The strength of the magnetic coupling increases as the adjustable gap decreases, and the adjustable gap of each of the plurality of roller assemblies is different.

Each of the rollers may be magnetically coupled to the drive hub such that the roller tends to rotate along with the drive hub. Optionally, each of the rollers may be magnetically coupled to the drive hub such that the roller may rotate in opposition to the drive hub when web tension is applied.

The web handling system also includes a drive motor operatively connected to at least one of the drive hubs of the roller assemblies through a drive belt. The drive motor may be operatively connected to each of the drive hubs through a corresponding drive belt.

The web handling system may also include a festoon assembly configured to allow the web material to pass therethrough. The festoon assembly includes a floating carriage supporting a first set of magnetic roller assemblies; and a fixed carriage supporting a second set of magnetic roller assemblies. The floating carriage is configured to move toward and away from the fixed carriage.

Each of the drive hubs includes a plurality of magnets. Each of the plurality of magnets may be oriented in an opposite direction to a proximate one of the plurality of magnets. That is, the magnets are oriented in an alternating fashion. The plurality of magnets are separated from one another by non-magnetic material.

Certain embodiments of the present invention also provide a method of controlling inertial forces within a web handling system. The method includes magnetically coupling a web roller to a drive hub, and rotating the drive hub, such that the rotaton causes the web roller to exert a force relative to web material passing around the web roller in response to the rotating.

The method also includes providing a gap between the web roller and the drive hub. The gap may be adjusted so that the magnetic coupling between the web roller and the drive hub may be adjusted.

### BRIEF DESCRIPTION OF SEVERAL VIEWS OF THE DRAWINGS

FIG. 1 illustrates a schematic diagram of a web handling system, according to an embodiment of the present invention.

FIG. 2 illustrates a front view of a magnetic roller system, according to an embodiment of the present invention.

FIG. 3 illustrates an axial cross section of a magnetic cap of a drive hub, according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

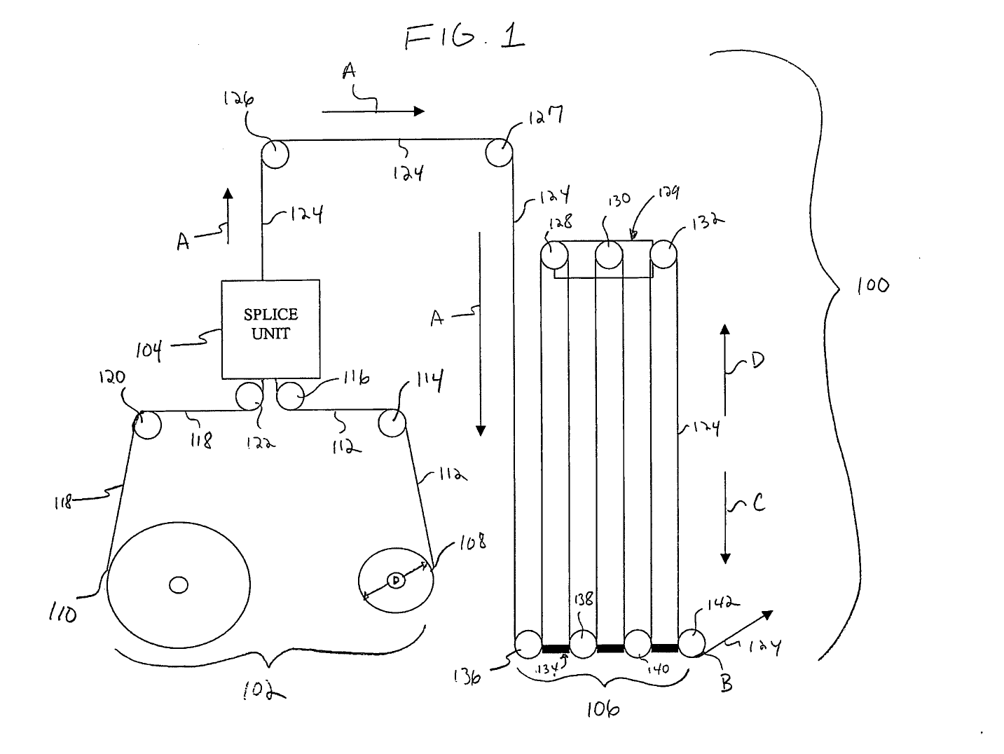

FIG. 1 illustrates a schematic diagram of a web handling system 100, according to an embodiment of the present invention. The system 100 includes a web feed roll assembly 102, a splice unit 104, and a festoon assembly 106.

The web feed roll assembly 102 includes a first roll 108 of web material and a second roll 110 of web material. Web material 112 is drawn off the first roll 108 over a magnetic roller 114 to a magnetic roller 116 and through the splice unit 104. The web material 118 may then be hand drawn from the second roll 110 over a magnetic roller 120 to a magnetic roller 122, and into the splice unit 104, which splices the head end of the web material 118 to the tail end of the web material 112. When the first roll 108 is reduced to a predetermined diameter D, the first roll 108 is stopped so that web material 112 is no longer drawn therefrom. The web material 112 is then spliced in the splice unit 104 to web material 118. The spliced web material 124 passes through the splice unit 104 toward a magnetic roller 126, and subsequently onto another magnetic roller 127. It is to be noted that the web material that exits the splice unit may be either the web material 112, or the web material 118, but for the sake of clarity and simplicity, the web material that passes through the splice unit 104 is referred to as the web material 124. The web material 112, 118, and 124 may be paper, textile, cloth, plastic, filter, film, or various such materials.

When the web material 118 is spliced to the web material 112, the movement of the web material 124 to the festoon assembly 106 in the direction of arrows A is halted. As the movement of the web material 124 is halted, the festoon assembly 106 moves in response thereto so that the accumulated web material 124 within the festoon assembly 106 continues to pass through the festoon assembly 106 at point B. That is, when the web feeding process to the festoon assembly 106 is halted during web splicing, web material still exits the web festoon assembly 106 to ensure that output of the web material to subsequent processing equipment continues at rated speed.

The festoon assembly 106 includes a floating carriage 129, having a plurality of magnetic rollers 128, 130, and 132, and a fixed carriage 134, having a plurality of magnetic rollers 136, 138, 140, and 142. As the web material 124 is pulled through the festoon assembly 106 at point B during a splice (i.e., when the input of web material 124 to the festoon assembly 106 is halted), the floating carriage 129 moves toward the fixed carriage 134 in the direction of arrow C, due to the fact that the accumulated web material 124 in the festoon assembly 106 is drawn upon for subsequent processes. In order to provide continued output of web material 124 through the festoon assembly 106 during a splice, accumulated web material 124 within the festoon assembly 106 is passed through the festoon assembly 106 at point B, thereby causing the floating carriage 129 to move toward the fixed carriage 134 to compensate for the lack of web material 124 being input into the festoon assembly 106. Once the web material 118 is spliced onto the web material 112, the web material 124 is fed into the festoon assembly 106 in the direction of arrows A, and the floating carriage 106 may move in the direction of arrow D, as the floating carriage 129 is replenished with web material 124 from the second roll 110.

While the web handling system 100 is shown with a number of magnetic rollers, more or less magnetic rollers may be used with the system 100. For example, instead of three magnetic rollers 128, 130, and 132, the floating carriage 129 may include more or less than three magnetic rollers. Additionally, the system 100 may use more than two rolls 108 and 110 rolls of web material. Also, the web handling system 100 may not use the festoon assembly 106. Embodiments of the present invention may be used with any web handling system that utilizes rollers.

In order to control the various inertial forces typically exerted on the web material 124 by the rollers, each roller is magnetically coupled to a hub that is operatively connected to a drive mechanism. Optionally, not all of the magnetic rollers within the system 100 need to be magnetically coupled. In any case, the drive mechanism is configured to counteract the torques, stresses, strains, and other inertial and frictional forces exerted on the web material 124.

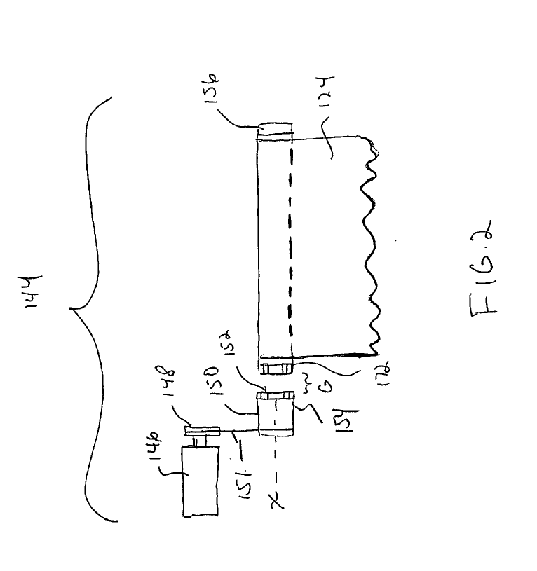

FIG. 2 illustrates a front view of a magnetic roller system 144, according to an embodiment of the present invention. The magnetic roller system 144 includes a drive motor 146 operatively connected to a drive pulley 148, which is in turn operatively connected a drive hub 150 through a drive belt 151. The drive motor 146 is activated to rotate the drive hub 150 about its axis X by way of the drive pulley 148 and drive belt 151. The drive pulley 148 and belt 151 system may be any conventional mechanism that is operable to translate rotation from the drive motor 146 to the drive hub 150. For example, the system may be a belt, gear system, cog, wormscrew, or any other such device that is capable of translating rotation of the motor 146 to the hub 150.

The drive hub 150 includes a magnetic end or cap 152 positioned at roller end 154. The magnetic cap 152 is configured to magnetically attract an end of a roller 156, which may be a carbon fiber roller. The roller 156 may be any of the magnetic rollers mentioned above. The magnetic cap 152 may be a cap on the roller end 154 of the drive hub, or may be integrally formed with the drive hub 150 at the roller end 154.

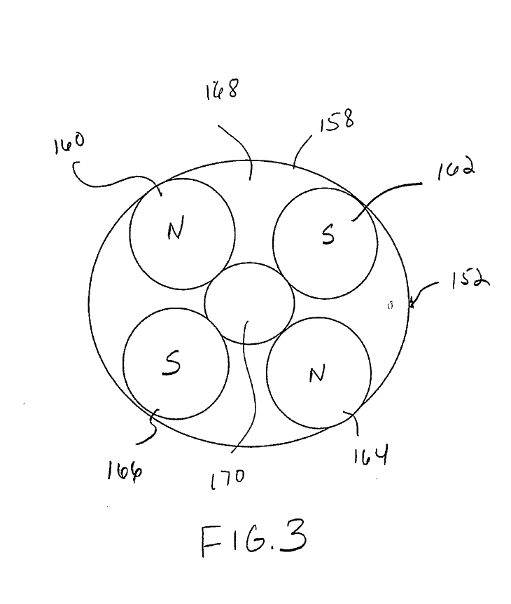

FIG. 3 illustrates an axial cross section of the magnetic cap 152 of the drive hub 150, according to an embodiment of the present invention. The cap 152 includes a main body 158 housing magnets 160, 162, 164, and 166 separated from one another by dielectric, or other non magnetic, material 168. A drive shaft channel 170 is positioned through the center of the cap 152. As shown in FIG. 3, the magnets 160, 162, 164, and 166 are oriented in alternating fashion such that the North poles of the magnets 160 and 164 are proximate the South poles of the magnets 162 and 166. Alternatively, more magnets may be included within the cap, and may be oriented in a similar alternating fashion. Alternatively, the magnetic cap 152 may be a magnetic insert positioned within the body of the drive hub. Optionally, instead of a magnetic cap 152, the magnets 160, 162, 164, and 166 may circumferentially positioned about the drive hub 150.

Referring again to FIG. 2, an end 172 of the roller 156 is magnetically coupled to the magnetic cap 152 of the drive hub 154. The end 172 may be a copper bulkhead or a corresponding ferrous cap that is configured to rotate along with the magnetic cap 152. Optionally, the end 172 may be a non-ferrous material that is configured to rotate in opposition to the magnetic cap 152. That is, the end 172 or all or a portion of the roller 156 may be a substance, such as a ferrous metal, that is attracted to or, in the alternative, repelled by a magnet. Optionally, the end 172 may merely be an end of the roller formed of a material that is magnetically attracted to, or repelled by, the magnetic cap 152.

As the drive hub rotates about the axis X, the roller 156 will rotate in response thereto. A variable gap G is defined between the magnetic cap 152 and the end 172. The magnetic roller 156 is influenced by the magnetic field produced by the magnetic cap 152 to a greater degree the smaller the gap G is. As the gap G is increased, the magnetic roller 156 will be influenced less by the magnetic cap 152, due to the fact that the magnetic roller 156 would be disposed within a weaker area of the magnetic field. Conversely, as the gap G is decreased, the magnetic roller 156 will be influenced more by the magnetic cap 152, due to the fact that the magnetic roller 156 would be disposed within a stronger area of the magnetic field. Hence, the smaller the gap G is (and the closer the magnetic roller 156 is to the magnetic cap 152), the more closely the magnetic roller 156 will move with, or in opposition to, the drive hub 150. Conversely, the larger the gap G is, the less closely the magnetic roller 156 will move with, or in opposition to, the drive hub 150.

Referring to FIGS. 1 and 2, the drive motor 146 may be operatively connected to all, or a portion of, the magnetic rollers within the system 100 through corresponding drive pulleys. The drive motor 146 is set at a speed that is greater than the speed the web material 112, 118, and 124 moves through the system 100. Optionally, each motor may operatively engage a separate and distinct roller, or additional motors may operatively engage a set of rollers (e.g., one drive motor may operatively engage the rollers 128, 130, and 132, while another drive motor may operatively engage the rollers 136, 138, 140, and 142).

The drive motor 146 moving the drive hub 150, and the magnetic coupling between the drive hub 150 and the roller 156, provides force to counteract the inertial forces of the roller 156. For example, during a splicing operation, when the input of web material 124 to the festoon assembly 106 is halted, the floating carriage 129 moves relative to the fixed carriage 134 as described above. This movement, and the continued movement of the web material 124 through the festoon assembly 106 at point B, causes the rollers within the system 100 to all rotate at different speeds, thereby exhibiting varying torques, and exerting varying inertial forces on the web material 124.

When the drive motor 146 is operatively connected to drive hubs 150 that are magnetically coupled to each of the rollers (e.g., one drive motor 146 having a plurality of drive belts 151 operatively connected to a plurality of drive hubs that are magnetically coupled to corresponding rollers), the magnetic coupling of the rollers to the drive hubs counteracts the inertial forces. While the drive motor 146 operates at a particular speed, thereby imparting a uniform speed of rotation to each of the drive belts 151 and drive hubs 150 to which each drive belt 151 is connected, the gaps G between each drive hub 150 and roller may be different. As such, each roller will be magnetically attracted to, or, in the alternative, repelled by, a corresponding drive hub in varying degrees.

For example, because the roller 142 rotates at a constant rate due to the fact that it is proximate the exit point B, the gap G between the roller 142 and its corresponding drive hub 150 may be greater, in order to provide a weaker magnetic coupling, than the gap G between the roller 136 and its corresponding drive hub 150. The stronger the magnetic coupling is between a roller and its corresponding drive hub, the more the roller will tend to move in response to the drive hub. Thus, because the magnetic coupling between the roller 136 and its corresponding drive hub is stronger than that of the roller 142 and its corresponding drive hub, the roller 136 exerts a stronger counteracting force (with respect to inertial and frictional forces exerted by the roller) than that of the slower rotating roller 136, which may require a greater change in velocity. The gaps G between the rollers and their corresponding drive hubs 150 may be adjusted so that appropriate amounts of inertia counteracting force are provided to each roller. In general, the rotational speed of each drive hub 150 is a function of changing web material speed through the system 100, the position of the floating carriage 129 in relation to the fixed carriage 134, the rate of positional change of the floating carriage 129 in relation to the fixed carriage 134, and the distance of the gap G.

Embodiments of the present invention may be used with various web handling systems, including those utilizing zero speed splicers or flying splicers. Additionally, embodiments of the present invention may be used with various systems and processes that utilize rollers used in the manufacture of various articles including paper, textile, clothing, plastic, film, filter and other such products. Embodiments of the present invention provide an improved, efficient and cost-effective roller that may be used with conventional web handling systems. Further, embodiments of the present invention provide a system and method for counteracting inertial forces during a web handling process.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A magnetic roller system configured for use within a web handling system, the system comprising:
a drive hub; and
a roller that is magnetically coupled to said drive hub, said roller configured to support a web of material, an adjustable gap being defined between said drive hub and said roller, wherein a strength of the magnetic coupling increases as said adjustable gap decreases.

2. The magnetic roller system of claim 1, wherein said roller is magnetically coupled to said drive hub such that said roller is allowed to rotate along with said drive hub.

3. The magnetic roller system of claim 1, wherein said roller is magnetically coupled to said drive hub such that said roller is allowed to rotate in opposition to said drive hub.

4. The magnetic roller system of claim 1, further comprising a drive motor operatively connected to said drive hub through a drive belt.

5. The magnetic roller system of claim 4, further comprising a plurality of drive hubs and rollers, wherein said drive motor is operatively connected to each of said drive hubs through a separate drive belt.

6. The magnetic roller system of claim 1, wherein the web handling system is configured for use with a web of at least one of paper, plastic, film, filter, textile, and cloth.

7. The magnetic roller system of claim 1, wherein the magnetic roller system is used within a festoon assembly.

8. The magnetic roller system of claim 1, wherein said drive hub comprises a plurality of magnets, wherein each of said plurality of magnets is oriented in an opposite direction to a proximate one of said plurality of magnets.

9. The magnetic roller system of claim 8, wherein said plurality of magnets are separated by non-magnetic material.

10. The magnetic roller system of claim 1, wherein the web handling system is a zero-speed splice web handling system.

11. The magnetic roller system of claim 1, wherein said roller is magnetically coupled to said drive hub to counteract inertial forces of web handling rollers.

12. A web handling system, comprising:
a plurality of rolls of web material;
a splice unit configured to splice a first end of web material from a first of said plurality of rolls to a second end of web material from a second of said plurality of rolls;
a plurality of magnetic roller assemblies supporting said web material throughout the web handling system, each of said plurality of magnetic roller assemblies comprising:
a drive hub; and
a roller that is magnetically coupled to said drive hub, said roller configured to support said web of material so that said web of material passes around at least a portion of said roller, an adjustable gap being defined between said drive hub and said roller, wherein a strength of the magnetic coupling increases as said adjustable gap decreases, and wherein said adjustable gap of each of said plurality of magnetic roller assemblies is different.

13. The web handling system of claim 12, wherein each of said rollers is magnetically coupled to said drive hub such that said roller are allowed to rotate along with said drive hub.

14. The web handling system of claim 12, wherein each of said rollers is magnetically coupled to said drive hub such that said roller are allowed to rotate in opposition to said drive hub.

15. The web handling system of claim 12, further comprising a drive motor operatively connected to at least one of said drive hubs of said magnetic roller assemblies through a drive belt.

16. The web handling system of claim 15, wherein said drive motor is operatively connected to each of said drive hubs through a corresponding drive belt.

17. The web handling system of claim 12, wherein the web handling system is configured for use with a web of at least one of paper, plastic, film, filter, textile, and cloth.

18. The web handling system of claim 12, further comprising a festoon assembly configured to allow said web material to pass therethrough, said festoon assembly comprising:
a floating carriage supporting a first set of magnetic roller assemblies; and
a fixed carriage supporting a second set of magnetic roller assemblies, said floating carriage configured to move toward and away from said fixed carriage, wherein said web material passes through said festoon assembly.

19. The web handling system of claim 12, wherein each of said drive hubs comprises a plurality of magnets, wherein each of said plurality of magnets is oriented in an opposite direction to a proximate one of said plurality of magnets.

20. The web handling system of claim 19, wherein said plurality of magnets are separated by non-magnetic material.

21. The web handling system of claim 12, wherein the web handling system is a zero-speed splice web handling system.

22. The web handling system of claim 12, wherein said roller is magnetically coupled to said drive hub to counteract inertial forces on the web of material.

23. A method of controlling inertial forces within a web handling system, the method comprising:
magnetically coupling a web roller to a drive hub; and
rotating the drive hub, wherein said rotating causes the web roller to exert an inertia counteracting force in response to said rotating.

24. The method of claim 23, further comprising providing a gap between the web roller and the drive hub.

25. The method of claim 24, further comprising adjusting the gap between the web roller and the drive hub so that the magnetic coupling between the web roller and the drive hub may be adjusted.

26. The method of claim 23, wherein said rotating comprises allowing rotation of the roller along with the drive hub.

27. The method of claim 23, wherein said rotating comprises allowing rotation of the roller in opposition to the drive hub.

28. The method of claim 23, wherein the web handling system is configured for use with a web of at least one of paper, plastic, film, filter, textile, and cloth.

29. The magnetic roller system of claim 23, wherein the web handling system is a zero-speed splice web handling system.
